(19) United States
(12) Patent Application Publication
(10) Pub. No.: US 2022/0113409 A1
(43) Pub. Date: Apr. 14, 2022

(54) DISTANCE MEASURING DEVICE

(71) Applicant: DENSO CORPORATION, Kariya-city (JP)

(72) Inventor: Masahiro YAMAMOTO, Kariya-city (JP)

(21) Appl. No.: 17/645,572

(22) Filed: Dec. 22, 2021

Related U.S. Application Data
(63) Continuation of application No. PCT/JP2020/023408, filed on Jun. 15, 2020.

(30) Foreign Application Priority Data
Jun. 27, 2019 (JP) 2019-119635

(51) Int. Cl. G01S 17/08; G01S 7/481; G01K 1/14; G01S 17/931

(52) U.S. Cl. CPC G01S 17/08; G01S 7/4813; G01S 17/931; G01S 7/4817; G01K 1/14

(57) ABSTRACT

A distance measuring device is configured to emit transmission waves and detect reflected waves from an object, to measure a distance to the object. The device includes a housing, a transmission window that is provided to an opening of the housing and through which the transmission waves and the reflected waves are transmitted, a heater provided to the transmission window and heats the transmission window, a reflected wave side board whose edge is close to the transmission window in a space on a detection side of the reflected waves formed by dividing a space on the transmission window side in the housing into a space on an emission side of the transmission waves and the space on the detection side of the reflected waves, and a temperature sensor detecting a temperature of the heater. The temperature sensor is mounted on the transmission window side of the reflected wave side board.

### CROSS-REFERENCE TO RELATED APPLICATION

The present application is based on and claims the benefit of priority from earlier Japanese Patent Application No. 2019-119635 filed Jun. 27, 2019, the description of which is incorporated herein by reference.

### BACKGROUND

### Technical Field

The present disclosure relates to a distance measuring device.

### Related Art

As a distance measuring device that is mounted to a vehicle and measures a distance to an object present in front of the vehicle, there is a distance measuring device that emits transmission waves frontward and detects reflected waves of the transmission waves from the object to measure a distance to the object.

### SUMMARY

As an aspect of the present disclosure, a distance measuring device is provided which is configured to emit transmission waves and detect reflected waves from an object to which the transmission waves are emitted, to measure a distance to the object. The device includes: a housing; a transmission window that is provided to an opening of the housing and through which the transmission waves and the reflected waves are transmitted; a heater that is provided to the transmission window and heats the transmission window; a reflected wave side board whose edge is close to the transmission window in a space on a detection side of the reflected waves formed by dividing a space on the transmission window side in the housing into a space on an emission side of the transmission waves and the space on the detection side of the reflected waves; and a temperature sensor that detects a temperature of the heater. The temperature sensor is mounted on the transmission window side of the reflected wave side board.

### BRIEF DESCRIPTION OF THE DRAWINGS

In the accompanying drawings:

FIG. 1 is a perspective view illustrating an appearance of a lidar device;

FIG. 2 is an exploded perspective view of the lidar device;

FIG. 3 is a perspective view illustrating a configuration of the interior of a housing body;

FIG. 4 is a schematic view of a configuration of the interior of a housing illustrated from the right side with a scanning part omitted;

FIG. 5 is a view illustrating a configuration of the inner surface of a cover; and

FIG. 6 is a perspective view illustrating a configuration of the interior of a housing body according to another embodiment.

### DETAILED DESCRIPTION OF THE PREFERRED EMBODIMENTS

As a distance measuring device that is mounted to a vehicle and measures a distance to an object present in front of the vehicle, there is a distance measuring device that emits transmission waves frontward and detects reflected waves of the transmission waves from the object to measure a distance to the object.

Typically, the distance measuring device has a housing at the front of which a transmission window through which the transmission waves and the reflected wave transmit is provided.

However, if snow, rainwater, and the like adheres to the transmission window, measurement accuracy of the distance measuring device may decrease.

Hence, JP-T-2015-506459 discloses providing a heater that heats a transmission window, to the transmission window to remove snow, rainwater, and the like.

The above distance measuring device in which the heater is provided to the transmission window typically controls a temperature of the heater according to an outside air temperature. However, if a sensor detecting an outside air temperature has failed, the heater may be abnormally heated. Hence, it is preferable to use a temperature sensor for detecting a temperature of the sensor. For example, it can be considered that the temperature sensor is provided to the transmission window. However, as a result of detailed examinations by the inventor, a problem was found that, for example, when the transmission window is curved, a temperature sensor cannot be easily provided to the curved surface, and a problem was found that, for example, when the transmission window is made of resin, since special implementation for providing the temperature sensor to resin is required, man-hours and manufacturing cost increase.

An aspect of the present disclosure provides a distance measuring device that can detect a temperature of a heater with a simple configuration.

Hereinafter, an exemplified embodiment of the present disclosure will be described with reference to the drawings.

### [1. Configuration]

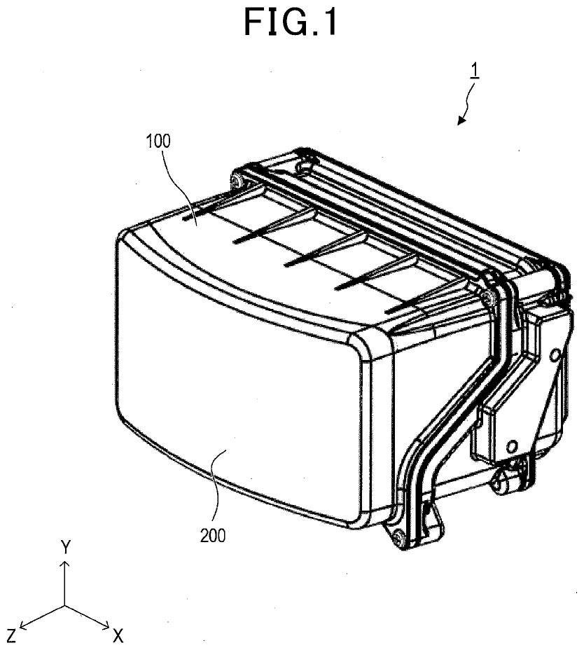

A lidar device 1 illustrated in FIG. 1 emits light as transmission waves and detects reflected waves of the emitted light to measure a distance to an object. The lidar device 1 is mounted to a vehicle and is used for detecting various objects present in front of the vehicle. The lidar is also represented as LIDAR. LIDAR is an abbreviation for Light Detection and Ranging.

As illustrate in FIG. 1, the lidar device 1 includes a housing 100 and a transmission window 200. The housing 100 is a resin box having a rectangular parallelepiped shape, one surface of which is opened.

Hereinafter, a direction along a longitudinal direction of an opening having a substantially rectangular shape of the housing 100 is defined as an X axis direction. A direction along a short length direction of the opening is defined as a Y direction. A direction orthogonal to an X-Y plane is defined as a Z direction. In a state where the lidar device 1 is disposed in the vehicle so that an X-Z plane is horizontal, right and left in the X direction and up and down in the Y direction are defined with viewing from the opening side of the housing 100. In the Z direction, the opening side of the housing 100 is defined as the front, and the depth side of the housing 100 is defined as the rear.

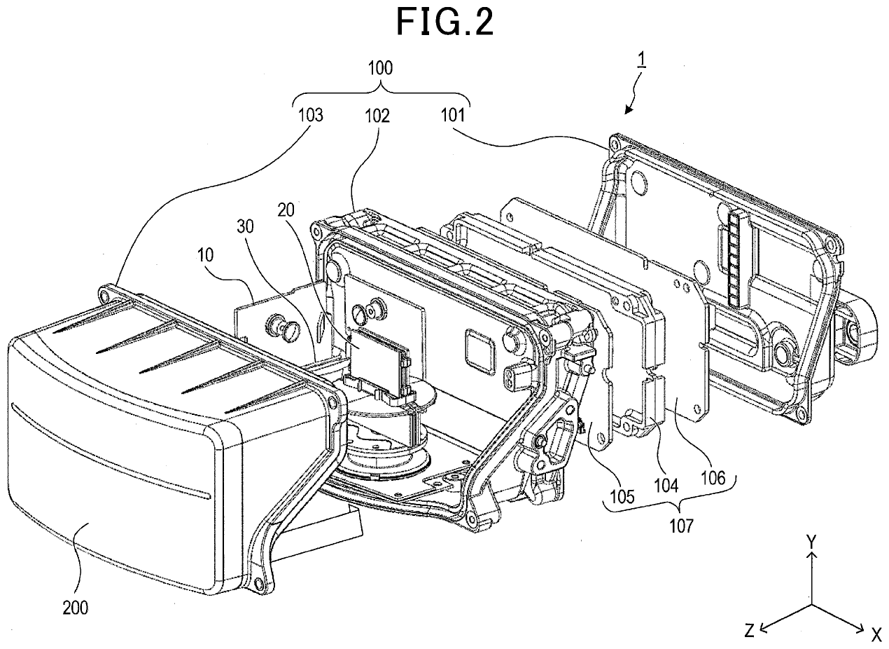

As illustrated in FIG. 2, the housing 100 includes a rear cover 101, a housing body 102, and a front cover 103. A main board 107 configured by arranging two control boards 105, 106 so as to sandwich an inner frame 104 in a front-rear direction is accommodate between the rear cover 101 and the housing body 102. A control CPU is mounted on the main board 107. An irradiation part 10, a scanning part 20, and a detection part 30 are accommodate between the housing body 102 and the front cover 103 in a state where the irradiation part 10, the scanning part 20, and the detection part 30 are fitted to a frame, not shown. The transparent transmission window 200 through light is transmitted is provided at the front of the front cover 103, that is, the opening of the housing 100.

### [2. Scanning Part]

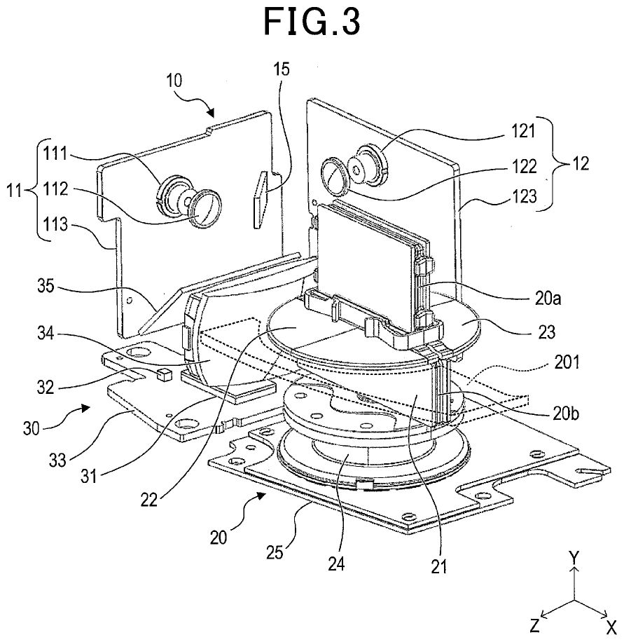

As illustrated in FIG. 3, the scanning part 20 includes a mirror module 21, a pair of partition boards 22, 23, a motor 24, and a motor board 25. The motor 24 is mounted on the motor board 25. The mirror module 21 stands on the motor 24. The mirror module 21 and the pair of partition boards 22, 23 fixed to the mirror module 21 rotate around a rotation axis in accordance with drive of the motor 24.

The mirror module 21 is a flat plate member on both surfaces of which a pair of deflecting mirrors that reflect light are mounted.

The pair of partition boards 22, 23 is configured by dividing a circular plate member into two semicircular parts. The pair of partition boards 22, 23 is fixed in the vicinity of the center of the mirror module 21 in the vertical direction so as to be orthogonal to an axis of rotation in a state where the mirror module 21 is interposed between the partition boards 22, 23.

Hereinafter, an upper portion of the mirror module 21 with respect to the pair of partition boards 22, 23 is referred to as an irradiation deflection part 20a, and a lower portion of the mirror module 21 with respect to the pair of partition boards 22, 23 is referred to a detection deflection part 20b.

The motor board 25 is disposed to face a lower surface of the housing body 102 so as to be parallel to the pair of partition boards 22, 23, that is, orthogonal to the axis of rotation. The motor board 25 has a substantially quadrangular shape. One side of the motor board 25 is disposed in the vicinity of the transmission window 200.

### [3. Irradiation Part]

As illustrated in FIG. 3, the irradiation part 10 includes a pair of light emitting modules 11, 12. The irradiation part 10 may include an irradiation side reflecting mirror 15.

The light emitting module 11 includes a light source 111, a light emitting lens 112, and a light emitting board 113. The light source 111 is fitted to the light emitting board 113. The light emitting lens 112 is disposed to face a light emitting surface of the light source 111. A semiconductor laser is used for the light source 111. The light emitting lens 112 narrows a width of a beam emitted from the light source 111. Similarly, the light emitting module 12 has a light source 121, a light emitting lens 122, and a light emitting board 123. Since the light emitting module 12 is similar to the light emitting module 11, the description of the light emitting module 12 is omitted.

The irradiation side reflecting mirror 15 changes a travelling direction of light.

The light emitting module 11 is disposed so that light output from the light emitting module 11 directly enters the irradiation deflection part 20a

The light emitting module 12 is disposed so that the traveling direction of the light output from the light emitting module 12 is bent at substantially 90° by the irradiation side reflecting mirror 15, and the light enters the irradiation deflection part 20a.

The light emitting module 11 is disposed so as to output light from the left to the right in the X axis direction. The light emitting module 12 is disposed so as to output light from the rear to the front in the Z axis direction. That is, the light emitting board 113 is disposed to face a left side surface of the housing body 102. The light emitting board 123 is disposed to face a rear surface of the housing body 102. The irradiation side reflecting mirror 15 is disposed so as not to block a path of light traveling from the light emitting module 11 to the irradiation deflection part 20a.

### [4. Detection Part]

The detection part 30 includes a detection element 31, a temperature sensor 32, and a detection board 33. The detection part 30 includes a detection lens 34, and a detection side reflecting mirror 35.

The detection element 31 and the temperature sensor 32 are mounted on the detection board 33. The detection board 33 has a substantially quadrangular shape. The detection board 33 is disposed to face the lower surface of the housing body 102 so that one side of the detection board 33 is close to the transmission window 200. Mounting surfaces of the detection board 33 and the motor board 25 on which the detection element 31 and the motor 24 are mounted are on the substantially same plane.

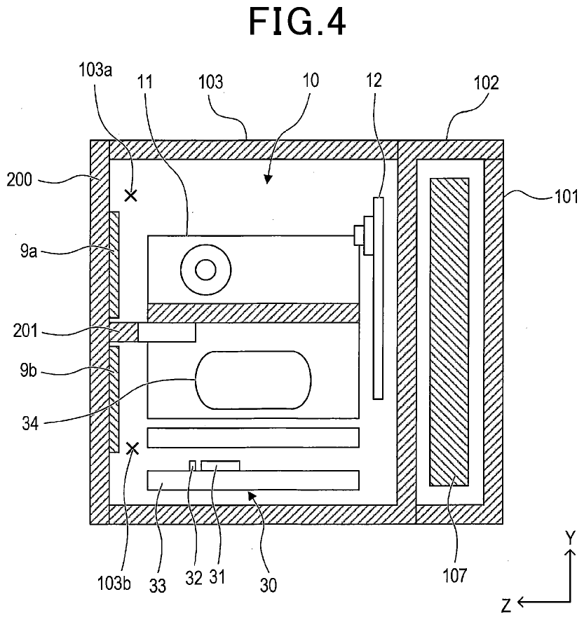

As illustrated in FIG. 4, the temperature sensor 32 is mounted on the detection board 33 on the transmission window 200 side and detects a temperature of a heater 9 described later provided to an inner surface of the transmission window 200. In the present embodiment, the temperature sensor 32 is mounted on the transmission window 200 side with reference to the center line of the detection substrate 33 in the x direction so as to be close to an edge of a side of the detection substrate 33 close to the transmission window 200 and not to be close to the center line of the detection substrate 33. In the present embodiment, the temperature sensor 32 is mounted between the detection element 31 and the transmission window 200. Specifically, the temperature sensor 32 is located on the left side of the detection element 31 in the X axis direction and on the front side of the detection element 31 in the Z axis direction. In other words, the temperature sensor 32 is located diagonally forward left of the detection element 31. The wording “between the detection element 31 and the transmission window 200 side” means an area of the detection board 33 closer to the transmission window 200 with reference to the detection element 31.

In the present embodiment, the detection element 31 is a light receiving element and has an APD array in which a plurality of APDs are arranged in a line. APD is an abbreviation for avalanche photodiode.

The detection lens 34 narrows light arriving from the detection deflection part 20b.

The detection side reflecting mirror 35 is disposed on the left side of the detection lens 34 in the X direction and changes a travelling direction of light. The detection element 31 is disposed under the detection side reflecting mirror 35.

The detection side reflecting mirror 35 is disposed so as to bend a path of light downward at substantially 90° so that the light entering the detection side reflecting mirror 35 from the detection deflection part 20b through the detection lens 34 arrives at the detection element 31.

The detection lens 34 is disposed between the detection deflection part 20b and the detection side reflecting mirror 35. The detection lens 34 narrows a diameter of an optical beam entering the detection element 31 so as to be approximately the element width of the APD.

### [5. Operation of Irradiation Part, Scanning Part, and Detection Part]

The light output from the light emitting module 11 enters the irradiation deflection part 20a. The traveling direction of the light output from the light emitting module 12 is bent at substantially 90° by the irradiation side reflecting mirror 15, and the light enters the irradiation deflection part 20a. The light that has entered the irradiation deflection part 20a is output in a direction according to a rotation angle of the mirror module 21 through the transmission window 200. The range to which light is emitted through the mirror module 21 is a scanning range. For example, when the forward direction along the Z axis is 0°, the range spread in the X direction at ±60° can be a scanning range.

Reflected light from an object to be tested located in a predetermined direction depending on a rotational position of the mirror module 21, that is, an emission direction of light from the irradiation deflection part 20a, is transmitted through the transmission window 200 and is reflected by the detection deflection part 20b.

Then, the reflected light is received by the detection element 31 through the detection lens 34 and the detection side reflecting mirror 35.

### [6. Transmission Window]

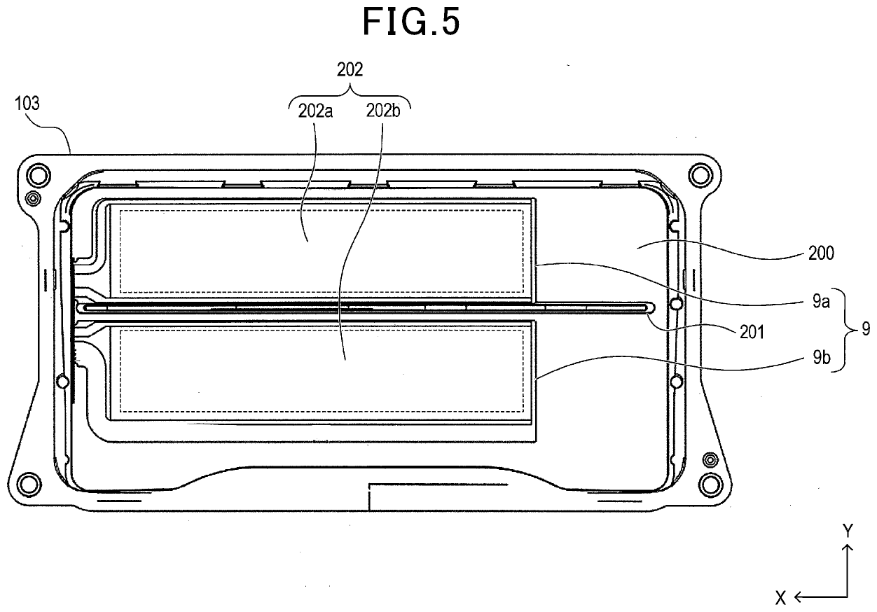

The transmission window 200 is a part disposed to face the irradiation part 10, the scanning part 20, and the detection part 30 and through which light of transmission waves and light of reflected waves are transmitted. As illustrated in FIG. 1 and FIG. 2, the transmission window 200 has a curved surface shape convex toward the outside of the housing 100. That is, the transmission window 200 has a shape curving a substantially rectangular plate member so as to be most projected (convex) at the center thereof in the X direction. The transmission window 200 is made of resin material. As illustrated in FIG. 3 and FIG. 5, the internal surface of the transmission window 200 is provided with a shielding plate 201, which is a plate member provided along the X direction, so as to project from the internal surface. The shielding plate 201 is provided in an upper area of the internal surface of the transmission window 200 with reference to the center in the Y direction.

As illustrate in FIG. 3 and FIG. 4, the shielding plate 201 is a partition board that partitions, together with the pair of partition boards 22, 23 included in the scanning part 20, the interior of the housing body 102 into a space 103a on the emission side of transmission waves and a space 103b on the detection side of reflected waves. Specifically, the shielding plate 201 and the pair of partition boards 22, 23 separate a space through which light output from the light sources 111, 121 and finally deflected by the irradiation deflection part 20a passes toward the transmission window 200 and a space through which reflected waves that has entered through the transmission window 200 directly pass before deflected by the detection deflection part 20b, from each other. The shielding plate 201 has a shape filling a gap between the pair of partition boards 22, 23 and the transmission window 200. The edge of the shielding plate 201 on the pair of partition boards 22, 23 side has a shape that is along the outer periphery of the pair of partition boards 22, 23. Between the shielding plate 201 and the pair of partition boards 22, 23, a slight gap (clearance) is provided so that the pair of partition boards 22, 23 can rotate freely according to the rotation of the motor 24.

The shielding plate 201 and the pair of partition boards 22, 23 are made of resin material blocking the transmission of laser beams emitted from the light sources 111, 121. The shielding plate 201 and the pair of partition boards 22, 23 block light of transmission waves diffusely reflected in the space 103a on the emission side of the transmission waves inside the housing body 102 from entering the space 103b on the detection side of the reflected waves. Hence, erroneous detection of the diffusely reflected light of transmission waves by the detection part 30 can be avoided, whereby accuracy in distance measurement increases.

### [7. Heater]

As illustrated in FIG. 5, the heater 9 that heats the transmission window 200 is provided to the inner surface of the transmission window 200.

The heater 9 includes an irradiation side heater 9a disposed in an area facing the space 103a on the emission side of transmission waves of the inner surface of the transmission window 200 and a detection side heater 9b disposed in an area facing the space 103b on the detection side of reflected waves of the inner surface of the transmission window 200.

The heater 9 is disposed so as to cover a transmission area 202, through which at least one of transmission waves and reflected wave detected by the detection part 30 is transmitted, of the inner surface of the transmission window 200. Specifically, the heater 9 is disposed as below.

The transmission area 202 includes a transmission wave transmission area 202a through which transmission waves are transmitted and a reflected wave transmission area 202b through which reflected waves to be detected by the detection part 30 are transmitted. Specifically, the transmission wave transmission area 202a is an area, through which light of transmission waves emitted toward the scanning range is directly transmitted, of the inner surface of the transmission window 200. The reflected wave transmission area 202b is an area of the inner surface of the transmission window 200. When an object is present at a position within the scanning range, reflected waves detected by the detection part 30 as reflected waves from the object are transmitted through the reflected wave transmission area 202b.

The irradiation side heater 9a is disposed so as to cover the transmission wave transmission area 202a. The detection side heater 9b is disposed so as to cover the reflected wave transmission area 202b.

The heater 9 is formed on a film substrate sticked on the inner surface of the transmission window 200. Various wiring patterns are formed on the film substrate. The various wiring patterns are formed by laminating conductor layers on a surface of a film insulation substrate and etching the conductor layers. As the conductor, copper is preferably used.

### [8. Effects]

According to the embodiment described above, the following effects can be provided.

(8a) The lidar device 1 according to the present embodiment includes the temperature sensor 32 that detects a temperature of the heater 9. Hence, in a state where temperature control for the heater 9 is being performed base on an outside air temperature, even when a sensor that measures the outside air temperature has failed, the heater 9 can be prevented from being abnormally heated. Hence, for example, if the temperature sensor 32 has detected a temperature equal to or more than a predetermined value, stopping heating the heater 9 can prevent the heater 9 from being abnormally heated.

Specifically, in the present embodiment, since the temperature sensor 32 is mounted on the transmission window 200 side of the detection board 33, special implementation is not required compared with, for example, a case where a temperature sensor is mounted to a resin transmission window. Hence, a temperature of the heater 9 mounted to the transmission window 200 can be detected with a simple configuration. In addition, in the present embodiment, since the temperature sensor 32 is far from heat sources other than the heater 9, the temperature sensor 32 can be resistant to the influence of the other heat sources when a temperature of the heater 9 is detected. The other heat sources include, for example, the light sources 111, 121 mounted to the light emitting boards 113, 123 that generate heat due to high output and the control CPU mounted on the main board 107.

(8b) In the present embodiment, the temperature sensor 32 is mounted between the detection element 31 and the transmission window 200. Hence, the temperature sensor 32 can be used for detecting a temperature of the detection element 31. That is, since the detection element 31 is easily subject to the influence of heat, it is preferable to dispose the temperature sensor in the vicinity of the detection element 31 to detect a temperature of the detection element 31. In this regard, according to the present embodiment, since the temperature sensor 32 is not only mounted between the detection element 31 and the transmission window 200 and located in the vicinity of the transmission window 200 but also located in the vicinity of the detection element 31, the temperature sensor 32 can be also used for detecting a temperature of the detection element 31.

In the present embodiment, the detection board 33 and the motor board 25 correspond to a reflected wave side board, the irradiation deflection part 20a of the mirror module 21 corresponds to an irradiation mirror, and the detection deflection part 20b of the mirror module 21 corresponds to a detection mirror.

### [9. Other Embodiments]

The present disclosure is not limited to the above embodiment and include various embodiments.

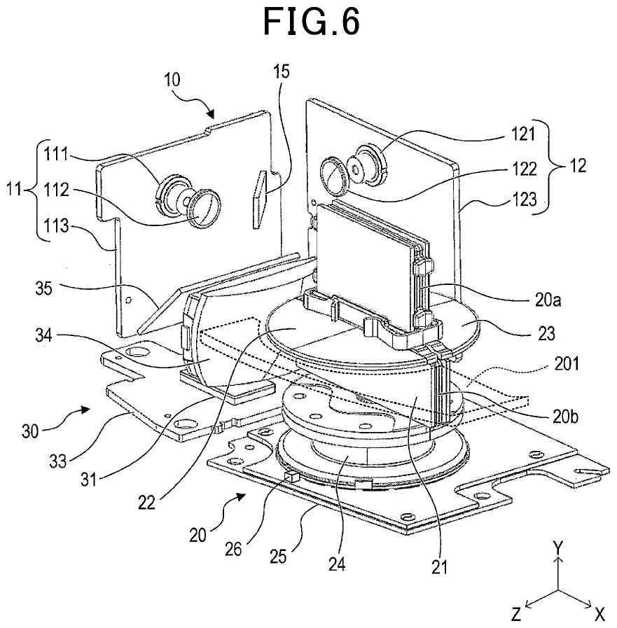

(9a) In the above embodiment, the temperature sensor 32 is mounted on the detection board 33. However, as illustrated in FIG. 6, a temperature sensor 26 may be mounted on the motor board 25. The temperature sensor 26 is mounted on the transmission window 200 side of the motor board 25. In the example illustrated in FIG. 6, the temperature sensor 26 is mounted on the transmission window 200 side with reference to the center line of the motor board 25 in the x direction so as to be close to an edge of a side of the motor board 25 close to the transmission window 200 and not to be close to the center line of the motor board 25. In the example illustrated in FIG. 6, the temperature sensor 26 is mounted between motor 24 on the motor board 25 and the transmission window 200. Specifically, the temperature sensor 32 is located on the front side of the motor 24 in the Z axis direction. The wording “between the motor 24 and the transmission window 200” means an area of the motor board 25 closer to the transmission window 200 with reference to the motor 24. Hence, as in the embodiment described above, a temperature of the heater 9 can be detected with a simple configuration without special implementation. In addition, since the temperature sensor 26 is far from heat sources other than the heater 9, and the heat generated by the motor 24 is sufficiently lower than the heat generated by the light sources 111, 121, the control CPU, and the like, the temperature sensor 26 can be resistant to the influence of the other heat sources when a temperature of the heater 9 is detected.

(9b) In the above embodiment, the mirror module 21 rotates around the rotation axis in accordance with drive of the motor 24. That is, the motor 24 rotates both of the irradiation deflection part 20a and the detection deflection part 20, which are integrated with each other. However, when the irradiation deflection part and the detection deflection part are separated from each other, the motor may rotate one of the irradiation mirror functioning as the irradiation deflection part and the detection mirror functioning as the detection deflection part.

(9c) In the above embodiment, the heater 9 is provided to an inner surface of the transmission window 200. However, the heater 9 may be provided to an outer surface of the transmission window 200.

(9d) In the above embodiment, the lidar device 1 is exemplified as a distance measuring device. However, the type of the distance measuring device is not limited to this. For example, the distance measuring device may be a millimeter wave radar device, an ultrasonic sensor, or the like.

(9e) In the above embodiment, the lidar device 1 is mounted to the front of the vehicle. However, the position of the lidar device 1 mounted to the vehicle is not limited to this. For example, the lidar device 1 may be mounted to the periphery of the vehicle, such as the side or the rear of the vehicle.

(9f) The functions included in one element of the above embodiment may be divided into a plurality of elements. The functions included in a plurality of elements may be integrated into one element. Part of the configuration of the above embodiment may be omitted. At least part of the configuration of the above embodiment may be added to or substituted for the configuration of the other embodiments.

As an aspect of the present disclosure, a distance measuring device (1) is provided which is configured to emit transmission waves and detect reflected waves from an object to which the transmission waves are emitted, to measure a distance to the object. The device includes: a housing (100); a transmission window (200) that is provided to an opening of the housing and through which the transmission waves and the reflected waves are transmitted; a heater (9) that is provided to the transmission window and heats the transmission window; a reflected wave side board (25, 33) whose edge is close to the transmission window in a space (103b) on a detection side of the reflected waves formed by dividing a space on the transmission window side in the housing into a space (103a) on an emission side of the transmission waves and the space (103b) on the detection side of the reflected waves; and a temperature sensor (26, 32) that detects a temperature of the heater. The temperature sensor is mounted on the transmission window side of the reflected wave side board.

According to the above configuration, a temperature of a heater can be detected with a simple configuration.

What is claimed is:

1. A distance measuring device configured to emit transmission waves and detect reflected waves from an object to which the transmission waves are emitted, to measure a distance to the object, the device comprising:
a housing;
a transmission window that is provided to an opening of the housing and through which the transmission waves and the reflected waves are transmitted;
a heater that is provided to the transmission window and heats the transmission window;
a reflected wave side board whose edge is close to the transmission window in a space on a detection side of the reflected waves formed by dividing a space on the transmission window side in the housing into a space on an emission side of the transmission waves and the space on the detection side of the reflected waves; and
a temperature sensor that detects a temperature of the heater, wherein
the temperature sensor is mounted on the transmission window side of the reflected wave side board.

2. The distance measuring device according to claim 1, wherein
the reflected wave side board is a detection board on which a detection element that detects the reflected waves is mounted, and
the temperature sensor is mounted on the detection board, between the detection element and the transmission window.

3. The distance measuring device according to claim 2, wherein
the temperature sensor is used for detecting a temperature of the detection element.

4. The distance measuring device according to claim 1, wherein the reflected wave side board is a motor board on which a motor that rotates, around a rotation axis, at least one of an irradiation mirror disposed in the space on the emission side of the transmission waves and a detection mirror disposed in the space on the detection side of the reflected waves, and
the temperature sensor is mounted on the motor board, between the motor and the transmission window.
